(19) United States
(12) Patent Application Publication
(10) Pub. No.: US 2026/0329367 A1
(43) Pub. Date: Oct. 22, 2026

(54) FREQUENCY DEVIATION DETECTION AND RESPONSE WITH IOT-ENABLED MONITORS

(71) Applicant: Volta Insite (US) Inc., Cornelius, NC (US)

(72) Inventors: Karl Lindstrom, Sunnyvale, CA (US); Denis Kouroussis, Markham (CA); Daniel Montbriand, Santa Cruz, CA (US); Karimulla Raja Shaikh, Cupertino, CA (US); Jaspreet Singh, Brampton (CA)

(73) Assignee: Volta Insite (US) Inc., Cornelius, NC (US)

(21) Appl. No.: 19/706,006

(22) Filed: Jun. 12, 2026

Related U.S. Application Data
(63) Continuation-in-part of application No. 19/690,329, filed on May 28, 2026.
Application No. 19/690,329 is a continuation-in-part of application No. 19/643,944, filed on Apr. 10, 2026.
Application No. 19/643,944 is a continuation-in-part of application No. 19/630,591, filed on Mar. 27, 2026.
Application No. 19/630,591 is a continuation-in-part of application No. 19/565,654, filed on Mar. 13, 2026.
(60) Provisional application No. 63/771,714, filed on Mar. 14, 2025.
(60) Provisional application No. 63/779,393, filed on Mar. 28, 2025.
(60) Provisional application No. 63/787,764, filed on Apr. 12, 2025.
(60) Provisional application No. 63/814,170, filed on May 29, 2025.
(60) Provisional application No. 63/824,111, filed on Jun. 15, 2025.
(60) Provisional application No. 63/842,417, filed on Jul. 11, 2025.
(60) Provisional application No. 63/868,054, filed on Aug. 21, 2025.
(60) Provisional application No. 63/875,633, filed on Sep. 4, 2025.
(60) Provisional application No. 63/886,244, filed on Sep. 23, 2025.
(60) Provisional application No. 63/893,080, filed on Oct. 3, 2025.
(60) Provisional application No. 63/908,902, filed on Oct. 31, 2025.
(60) Provisional application No. 63/920,989, filed on Nov. 19, 2025.
(60) Provisional application No. 63/920,997, filed on Nov. 19, 2025.
(60) Provisional application No. 63/927,701, filed on Nov. 30, 2025.
(60) Provisional application No. 63/933,557, filed on Dec. 8, 2025.
(60) Provisional application No. 63/951,992, filed on Dec. 31, 2025.
(60) Provisional application No. 63/969,898, filed on Jan. 28, 2026.
(60) Provisional application No. 63/980,195, filed on Feb. 11, 2026.
(60) Provisional application No. 63/980,279, filed on Feb. 11, 2026.
(60) Provisional application No. 63/991,428, filed on Feb. 26, 2026.
(60) Provisional application No. 63/991,451, filed on Feb. 26, 2026.
(60) Provisional application No. 63/994,200, filed on Mar. 2, 2026.
(60) Provisional application No. 64/004,156, filed on Mar. 12, 2026.
(60) Provisional application No. 64/019,355, filed on Mar. 27, 2026.
(60) Provisional application No. 64/019,355, filed on Mar. 27, 2026.
(60) Provisional application No. 64/042,022, filed on Apr. 17, 2026.
(60) Provisional application No. 64/042,022, filed on Apr. 17, 2026.
(60) Provisional application No. 64/051,859, filed on Apr. 28, 2026.
(60) Provisional application No. 64/051,859, filed on Apr. 28, 2026.
(60) Provisional application No. 64/054,043, filed on Apr. 30, 2026.
(60) Provisional application No. 64/054,043, filed on Apr. 30, 2026.
(60) Provisional application No. 64/055,383, filed on May 1, 2026.
(60) Provisional application No. 64/055,383, filed on May 1, 2026.

(51) Int. Cl. G06F 1/3296; G06F 1/28; G16Y 10/75; G16Y 20/30; G16Y 40/10; G16Y 40/35

(52) U.S. Cl. CPC G06F 1/3296; G06F 1/28; G16Y 10/75; G16Y 20/30; G16Y 40/10; G16Y 40/35

(57) ABSTRACT

A first industrial Internet of Things (IoT) electrical monitor (IIEM), within a plurality of IIEMs, is accessed. The first IIEM is coupled to a load management module. The first IIEM is also coupled to a first node within an electrical distribution system of an industrial environment. The industrial environment comprises a plurality of nodes. The industrial environment also includes a plurality of industrial devices. One or more of the industrial devices are coupled to the first node. The first IIEM monitors a frequency of alternating current (AC) power of the first node and detects that the frequency is below a first frequency threshold. The load management module throttles at least one function within a first industrial device that is within the plurality of industrial devices.

### RELATED APPLICATIONS

This application claims the benefit of U.S. provisional patent applications “Detection And Response To Frequency Deviations With IOT Enabled Monitors” Ser. No. 63/824,111, filed Jun. 15, 2025, “Frequency Deviation Detection And Response With IOT-Enabled Monitors” Ser. No. 63/842,417, filed Jul. 11, 2025, “Industrial Device Root Cause Analysis With Artificial Intelligence Agents” Ser. No. 63/868,054, filed Aug. 21, 2025, “Root Cause Analysis On Industrial Devices With Artificial Intelligence Agents” Ser. No. 63/875,633, filed Sep. 4, 2025, “Contactor Monitoring And Analysis With IOT-Enabled Monitors” Ser. No. 63/886,244, filed Sep. 23, 2025, “Variable Frequency Drive Isolation With IOT-Enabled Monitors” Ser. No. 63/893,080, filed Oct. 3, 2025, “Reconstruction Of Saturated Electrical Data With Industrial IOT Electrical Monitors” Ser. No. 63/908,902, filed Oct. 31, 2025, “Aggregated Analysis Of Electrical Signatures With Event Filters And Industrial IOT-Enabled Monitors” Ser. No. 63/920,989, filed Nov. 19, 2025, “Self-Regulating Industrial IOT-Enabled Monitors (IIEMS) With Event Filters” Ser. No. 63/920,997, filed Nov. 19, 2025, “Monitoring Variable Resolution Electrical Data With Industrial IOT Electrical Monitors” Ser. No. 63/927,701, filed Nov. 30, 2025, “Isolation For Electrical Analysis Of Industrial Equipment With Industrial IOT-Enabled Monitors” Ser. No. 63/933,557, filed Dec. 8, 2025, “Managing Anomalous Events Associated With Industrial Devices With An Applications Engineer Artificial Intelligence Agent” Ser. No. 63/951,992, filed Dec. 31, 2025, “Automatic Initialization Of Industrial IOT-Enabled Monitors” Ser. No. 63/969,898, filed Jan. 28, 2026, “Initializing Industrial IOT-Enabled Monitors With Zero Crossing Time Lags” Ser. No. 63/980,195, filed Feb. 11, 2026, “Residual Back EMF Analysis With Industrial IOT-Enabled Monitors Coupled To Industrial Devices” Ser. No. 63/980,279, filed Feb. 11, 2026, “Recognizing Anomalous Events With Frequency Transformations By IOT-Enabled Monitors” Ser. No. 63/991,428, filed Feb. 26, 2026, “Internal Temperature Tracking Of Industrial Devices With IOT-Enabled Monitors” Ser. No. 63/991,451, filed Feb. 26, 2026, “Auto Channel Mapping For IOT-Enabled Monitors Coupled To Industrial Devices” Ser. No. 63/994,200, filed Mar. 2, 2026, “Root Cause Analysis Of An Anomalous Event With An Applications Engineer Artificial Intelligence Agent” Ser. No. 64/004,156, filed Mar. 12, 2026, “In-Place Testing Of Industrial Equipment With Industrial IOT Enabled Monitors And Electrical Injection” Ser. No. 64/019,355, filed Mar. 27, 2026, “Aggregating Electrical Signal Nodes With IOT Enabled Electrical Monitors” Ser. No. 64/042,022, filed Apr. 17, 2026, “Developing An Anomalous Event Chronology With IOT Enabled Electrical Monitors” Ser. No. 64/055,383, filed May 1, 2026, “Predicting Fuse Failure With IOT Enabled Electrical Monitors” Ser. No. 64/054,043, filed Apr. 30, 2026, “Detecting Anomalous Events By Work Cycle Waveform Shape” Ser. No. 64/051,859, filed Apr. 28, 2026, and “Electrical Signal Monitoring For Rapid Restart Detection With Timestamps” Ser. No. 64/077,428, filed May 29, 2026.

This application is also a continuation-in-part of U.S. patent application “Ground Fault Identification With IOT Enabled Monitors” Ser. No. 19/690,329, filed May 28, 2026, which claims the benefit of U.S. provisional patent applications “Ground Fault Identification With IOT Enabled Monitors” Ser. No. 63/814,170, filed May 29, 2025, “Detection And Response To Frequency Deviations With IOT Enabled Monitors” Ser. No. 63/824,111, filed Jun. 15, 2025, “Frequency Deviation Detection And Response With IOT-Enabled Monitors” Ser. No. 63/842,417, filed Jul. 11, 2025, “Industrial Device Root Cause Analysis With Artificial Intelligence Agents” Ser. No. 63/868,054, filed Aug. 21, 2025, “Root Cause Analysis On Industrial Devices With Artificial Intelligence Agents” Ser. No. 63/875,633, filed Sep. 4, 2025, “Contactor Monitoring And Analysis With IOT-Enabled Monitors” Ser. No. 63/886,244, filed Sep. 23, 2025, “Variable Frequency Drive Isolation With IOT-Enabled Monitors” Ser. No. 63/893,080, filed Oct. 3, 2025, “Reconstruction Of Saturated Electrical Data With Industrial IOT Electrical Monitors” Ser. No. 63/908,902, filed Oct. 31, 2025, “Aggregated Analysis Of Electrical Signatures With Event Filters And Industrial IOT-Enabled Monitors” Ser. No. 63/920,989, filed Nov. 19, 2025, “Self-Regulating Industrial IOT-Enabled Monitors (IIEMS) With Event Filters” Ser. No. 63/920,997, filed Nov. 19, 2025, “Monitoring Variable Resolution Electrical Data With Industrial IOT Electrical Monitors” Ser. No. 63/927,701, filed Nov. 30, 2025, “Isolation For Electrical Analysis Of Industrial Equipment With Industrial IOT-Enabled Monitors” Ser. No. 63/933,557, filed Dec. 8, 2025, “Managing Anomalous Events Associated With Industrial Devices With An Applications Engineer Artificial Intelligence Agent” Ser. No. 63/951,992, filed Dec. 31, 2025, “Automatic Initialization Of Industrial IOT-Enabled Monitors” Ser. No. 63/969,898, filed Jan. 28, 2026, “Initializing Industrial IOT-Enabled Monitors With Zero Crossing Time Lags” Ser. No. 63/980,195, filed Feb. 11, 2026, “Residual Back EMF Analysis With Industrial IOT-Enabled Monitors Coupled To Industrial Devices” Ser. No. 63/980,279, filed Feb. 11, 2026, “Recognizing Anomalous Events With Frequency Transformations By IOT-Enabled Monitors” Ser. No. 63/991,428, filed Feb. 26, 2026, “Internal Temperature Tracking Of Industrial Devices With IOT-Enabled Monitors” Ser. No. 63/991,451, filed Feb. 26, 2026, “Auto Channel Mapping For IOT-Enabled Monitors Coupled To Industrial Devices” Ser. No. 63/994,200, filed Mar. 2, 2026, “Root Cause Analysis Of An Anomalous Event With An Applications Engineer Artificial Intelligence Agent” Ser. No. 64/004,156, filed Mar. 12, 2026, “In-Place Testing Of Industrial Equipment With Industrial IOT Enabled Monitors And Electrical Injection” Ser. No. 64/019,355, filed Mar. 27, 2026, “Aggregating Electrical Signal Nodes With IOT Enabled Electrical Monitors” Ser. No. 64/042,022, filed Apr. 17, 2026, “Developing An Anomalous Event Chronology With IOT Enabled Electrical Monitors” Ser. No. 64/055,383, filed May 1, 2026, “Predicting Fuse Failure With IOT Enabled Electrical Monitors” Ser. No. 64/054,043, filed Apr. 30, 2026, and “Detecting Anomalous Events By Work Cycle Waveform Shape” Ser. No. 64/051,859, filed Apr. 28, 2026.

The U.S. patent application “Ground Fault Identification With IOT Enabled Monitors” Ser. No. 19/690,329, filed May 28, 2026 is also a continuation-in-part of U.S. patent application “Identification Of Electrical Signatures With Local Machine Learning Models On An IOT-Enabled Monitor” Ser. No. 19/643,944, filed Apr. 10, 2026, which claims the benefit of U.S. provisional patent applications “Identification Of Electrical Signatures With Local Machine Learning Models On An IOT-Enabled Monitor” Ser. No. 63/787,764, filed Apr. 12, 2025, “Ground Fault Identification With IOT Enabled Monitors” Ser. No. 63/814,170, filed May 29, 2025, “Detection And Response To Frequency Deviations With IOT Enabled Monitors” Ser. No. 63/824,111, filed Jun. 15, 2025, “Frequency Deviation Detection And Response With IOT-Enabled Monitors” Ser. No. 63/842,417, filed Jul. 11, 2025, “Industrial Device Root Cause Analysis With Artificial Intelligence Agents” Ser. No. 63/868,054, filed Aug. 21, 2025, “Root Cause Analysis On Industrial Devices With Artificial Intelligence Agents” Ser. No. 63/875,633, filed Sep. 4, 2025, “Contactor Monitoring And Analysis With IOT-Enabled Monitors” Ser. No. 63/886,244, filed Sep. 23, 2025, “Variable Frequency Drive Isolation With IOT-Enabled Monitors” Ser. No. 63/893,080, filed Oct. 3, 2025, “Reconstruction Of Saturated Electrical Data With Industrial IOT Electrical Monitors” Ser. No. 63/908,902, filed Oct. 31, 2025, “Aggregated Analysis Of Electrical Signatures With Event Filters And Industrial IOT-Enabled Monitors” Ser. No. 63/920,989, filed Nov. 19, 2025, “Self-Regulating Industrial IOT-Enabled Monitors (IIEMS) With Event Filters” Ser. No. 63/920,997, filed Nov. 19, 2025, “Monitoring Variable Resolution Electrical Data With Industrial IOT Electrical Monitors” Ser. No. 63/927,701, filed Nov. 30, 2025, “Isolation For Electrical Analysis Of Industrial Equipment With Industrial IOT-Enabled Monitors” Ser. No. 63/933,557, filed Dec. 8, 2025, “Managing Anomalous Events Associated With Industrial Devices With An Applications Engineer Artificial Intelligence Agent” Ser. No. 63/951,992, filed Dec. 31, 2025, “Automatic Initialization Of Industrial IOT-Enabled Monitors” Ser. No. 63/969,898, filed Jan. 28, 2026, “Initializing Industrial IOT-Enabled Monitors With Zero Crossing Time Lags” Ser. No. 63/980,195, filed Feb. 11, 2026, “Residual Back EMF Analysis With Industrial IOT-Enabled Monitors Coupled To Industrial Devices” Ser. No. 63/980,279, filed Feb. 11, 2026, “Recognizing Anomalous Events With Frequency Transformations By IOT-Enabled Monitors” Ser. No. 63/991,428, filed Feb. 26, 2026, “Internal Temperature Tracking Of Industrial Devices With IOT-Enabled Monitors” Ser. No. 63/991,451, filed Feb. 26, 2026, “Auto Channel Mapping For IOT-Enabled Monitors Coupled To Industrial Devices” Ser. No. 63/994,200, filed Mar. 2, 2026, “Root Cause Analysis Of An Anomalous Event With An Applications Engineer Artificial Intelligence Agent” Ser. No. 64/004,156, filed Mar. 12, 2026, and “In-Place Testing Of Industrial Equipment With Industrial IOT Enabled Monitors And Electrical Injection” Ser. No. 64/019,355, filed Mar. 27, 2026.

The U.S. patent application “Identification Of Electrical Signatures With Local Machine Learning Models On An IOT-Enabled Monitor” Ser. No. 19/643,944, filed Apr. 10, 2026 is also a continuation-in-part of U.S. patent application “Autonomous Identification Of Electrical Signatures With IOT-Enabled Monitors” Ser. No. 19/630,591, filed Mar. 27, 2026, which claims the benefit of U.S. provisional patent applications “Autonomous Identification Of Electrical Signatures With IOT-Enabled Monitors” Ser. No. 63/779,393, filed Mar. 28, 2025, “Identification Of Electrical Signatures With Local Machine Learning Models On An IOT-Enabled Monitor” Ser. No. 63/787,764, filed Apr. 12, 2025, “Ground Fault Identification With IOT Enabled Monitors” Ser. No. 63/814,170, filed May 29, 2025, “Detection And Response To Frequency Deviations With IOT Enabled Monitors” Ser. No. 63/824,111, filed Jun. 15, 2025, “Frequency Deviation Detection And Response With IOT-Enabled Monitors” Ser. No. 63/842,417, filed Jul. 11, 2025, “Industrial Device Root Cause Analysis With Artificial Intelligence Agents” Ser. No. 63/868,054, filed Aug. 21, 2025, “Root Cause Analysis On Industrial Devices With Artificial Intelligence Agents” Ser. No. 63/875,633, filed Sep. 4, 2025, “Contactor Monitoring And Analysis With IOT-Enabled Monitors” Ser. No. 63/886,244, filed Sep. 23, 2025, “Variable Frequency Drive Isolation With IOT-Enabled Monitors” Ser. No. 63/893,080, filed Oct. 3, 2025, “Reconstruction Of Saturated Electrical Data With Industrial IOT Electrical Monitors” Ser. No. 63/908,902, filed Oct. 31, 2025, “Aggregated Analysis Of Electrical Signatures With Event Filters And Industrial IOT-Enabled Monitors” Ser. No. 63/920,989, filed Nov. 19, 2025, “Self-Regulating Industrial IOT-Enabled Monitors (IIEMS) With Event Filters” Ser. No. 63/920,997, filed Nov. 19, 2025, “Monitoring Variable Resolution Electrical Data With Industrial IOT Electrical Monitors” Ser. No. 63/927,701, filed Nov. 30, 2025, “Isolation For Electrical Analysis Of Industrial Equipment With Industrial IOT-Enabled Monitors” Ser. No. 63/933,557, filed Dec. 8, 2025, “Managing Anomalous Events Associated With Industrial Devices With An Applications Engineer Artificial Intelligence Agent” Ser. No. 63/951,992, filed Dec. 31, 2025, “Automatic Initialization Of Industrial IOT-Enabled Monitors” Ser. No. 63/969,898, filed Jan. 28, 2026, “Initializing Industrial IOT-Enabled Monitors With Zero Crossing Time Lags” Ser. No. 63/980,195, filed Feb. 11, 2026, “Residual Back EMF Analysis With Industrial IOT-Enabled Monitors Coupled To Industrial Devices” Ser. No. 63/980,279, filed Feb. 11, 2026, “Recognizing Anomalous Events With Frequency Transformations By IOT-Enabled Monitors” Ser. No. 63/991,428, filed Feb. 26, 2026, “Internal Temperature Tracking Of Industrial Devices With IOT-Enabled Monitors” Ser. No. 63/991,451, filed Feb. 26, 2026, “Auto Channel Mapping For IOT-Enabled Monitors Coupled To Industrial Devices” Ser. No. 63/994,200, filed Mar. 2, 2026, and “Root Cause Analysis Of An Anomalous Event With An Applications Engineer Artificial Intelligence Agent” Ser. No. 64/004,156, filed Mar. 12, 2026.

The U.S. patent application “Autonomous Identification Of Electrical Signatures With IOT-Enabled Monitors” Ser. No. 19/630,591, filed Mar. 27, 2026 is also a continuation-in-part of U.S. patent application “Continuous Capture Of Electrical Signatures With IOT Enabled Monitors” Ser. No. 19/565,654, filed Mar. 13, 2026, which claims the benefit of U.S. provisional patent applications “Continuous Capture Of Electrical Signatures With IOT Enabled Monitors” Ser. No. 63/771,714, filed Mar. 14, 2025, “Autonomous Identification Of Electrical Signatures With IOT-Enabled Monitors” Ser. No. 63/779,393, filed Mar. 28, 2025, “Identification Of Electrical Signatures With Local Machine Learning Models On An IOT-Enabled Monitor” Ser. No. 63/787,764, filed Apr. 12, 2025, “Ground Fault Identification With IOT Enabled Monitors” Ser. No. 63/814,170, filed May 29, 2025, “Detection And Response To Frequency Deviations With IOT Enabled Monitors” Ser. No. 63/824,111, filed Jun. 15, 2025, “Frequency Deviation Detection And Response With IOT-Enabled Monitors” Ser. No. 63/842,417, filed Jul. 11, 2025, “Industrial Device Root Cause Analysis With Artificial Intelligence Agents” Ser. No. 63/868,054, filed Aug. 21, 2025, “Root Cause Analysis On Industrial Devices With Artificial Intelligence Agents” Ser. No. 63/875,633, filed Sep. 4, 2025, “Contactor Monitoring And Analysis With IOT-Enabled Monitors” Ser. No. 63/886,244, filed Sep. 23, 2025, “Variable Frequency Drive Isolation With IOT-Enabled Monitors” Ser. No. 63/893,080, filed Oct. 3, 2025, “Reconstruction Of Saturated Electrical Data With Industrial IOT Electrical Monitors” Ser. No. 63/908,902, filed Oct. 31, 2025, “Aggregated Analysis Of Electrical Signatures With Event Filters And Industrial IOT-Enabled Monitors” Ser. No. 63/920,989, filed Nov. 19, 2025, “Self-Regulating Industrial IOT-Enabled Monitors (IIEMS) With Event Filters” Ser. No. 63/920,997, filed Nov. 19, 2025, “Monitoring Variable Resolution Electrical Data With Industrial IOT Electrical Monitors” Ser. No. 63/927,701, filed Nov. 30, 2025, “Isolation For Electrical Analysis Of Industrial Equipment With Industrial IOT-Enabled Monitors” Ser. No. 63/933,557, filed Dec. 8, 2025, “Managing Anomalous Events Associated With Industrial Devices With An Applications Engineer Artificial Intelligence Agent” Ser. No. 63/951,992, filed Dec. 31, 2025, “Automatic Initialization Of Industrial IOT-Enabled Monitors” Ser. No. 63/969,898, filed Jan. 28, 2026, “Initializing Industrial IOT-Enabled Monitors With Zero Crossing Time Lags” Ser. No. 63/980,195, filed Feb. 11, 2026, “Residual Back EMF Analysis With Industrial IOT-Enabled Monitors Coupled To Industrial Devices” Ser. No. 63/980,279, filed Feb. 11, 2026, “Recognizing Anomalous Events With Frequency Transformations By IOT-Enabled Monitors” Ser. No. 63/991,428, filed Feb. 26, 2026, “Internal Temperature Tracking Of Industrial Devices With IOT-Enabled Monitors” Ser. No. 63/991,451, filed Feb. 26, 2026, and “Auto Channel Mapping For IOT-Enabled Monitors Coupled To Industrial Devices” Ser. No. 63/994,200, filed Mar. 2, 2026.

Each of the foregoing applications is hereby incorporated by reference in its entirety.

### FIELD OF ART

This application relates generally to analysis, and more particularly to frequency deviation detection and response with IoT-enabled monitors.

### BACKGROUND

Electricity appears in nature in a variety of forms that have been observed throughout history. Early scientists studied the properties of electric eels, static electricity, and conductive metals, and may have even developed rudimentary batteries. Lightning, though a particularly spectacular appearance of electricity, was not commonly known as electrical in origin until relatively recently. The fact that our own bodies and those of many other living creatures use electricity for internal communication was also unknown for thousands of years. Advances in technology and scientific methodology eventually allowed for increased insight into these and other appearances of electricity in nature, and scientists and engineers started to realize the practical applications of electricity as their understanding of it increased.

Early applications of electricity were limited. Historical records indicate that some cultures attempted to use the shocks of electric fish as medical treatments. There is also some speculation that the origins of electroplating and electrotherapy devices may have appeared long ago in a primitive form. But for many hundreds of years, electricity was primarily a curiosity with few practical applications, at least as far as we can tell from historical data. The understanding of electricity started to accelerate in the 17^{th} century along with many other advancements in science and math. With this increased understanding came more electrical devices in the 18^{th} century, though these were still primarily experimental devices. In the 19^{th} century, however, electrical devices started to have clear practical applications. Batteries, electrical circuits, and electric motors were developed during this time, the modern forms of which are used in many applications today. Progress continued in the following decades, eventually leading to photoelectric devices, radios, transistors, and countless other devices that utilize electricity.

Today, electricity and electrical devices are ubiquitous. Modern societies rely on electricity for illumination, transportation, climate control, communication, and manufacturing. Electric lights are commonplace in private homes, vehicles, businesses, and public areas. Electricity is used for transportation and traffic control in the form of electric trains, traffic lights, numerous electrical components of vehicles and, increasingly, electric automobiles. There are also efforts to develop commercial and military aircraft powered by electricity. Electric heaters, air conditioning units, and refrigerators and cooking appliances use electricity to heat and cool our homes and meals. Communication relies heavily on electricity in numerous applications including radio devices, internet communication, and phones. Even a letter sent through the mail is usually processed using devices powered by electricity. Manufacturing plants often use massive amounts of electricity to provide power to machines that automate the production of a wide variety of products.

Perhaps the greatest impact of electricity on modern life is that it has enabled the development of computing. Without electricity, modern computers would not be possible. Advances in electric devices and computing have gone hand in hand, as engineers have developed smaller, faster, and more efficient electrical transistors, allowing computers to be more powerful while shrinking in size and cost. More efficient and compact batteries have enabled the creation of mobile phones, laptops, and smartwatches as well as compact medical devices like pacemakers and integrated computers in appliances, vehicles, and industrial equipment. As our understanding of electricity advances, we can expect that many more applications will be developed. In all likelihood, there will be commonplace applications in the future that would seem fantastical to us today, just as our technology would seem fantastical to those who lived thousands of years ago.

### SUMMARY

Monitoring can apply to almost every area of life and business. It can be an essential ingredient for success, quality, and improvement in virtually any activity. In business, organizations can use monitoring to make informed decisions to better meet the needs of all stakeholders. For example, tracking key performance indicators (KPIs) such as customer satisfaction, input costs, revenue, etc. can help drive profitability. In healthcare, monitoring of patient conditions is key to providing care and enhancing positive patient outcomes. The environment can also benefit from activities such as monitoring air quality, water quality, and usage of natural resources. Effective monitoring can also provide clarity. For example, monitoring one's heart rate or blood pressure can provide an early indication of problems well before they affect other parts of the body. Monitoring can be applied to electrical distribution. As industries and digital systems become increasingly interconnected and power-intensive, disruptions in the electrical power supply, whether momentary or sustained, can lead to significant operational consequences. Effective monitoring of the power grid is therefore essential to ensure that potential issues are identified early and addressed in a timely manner.

Disclosed implementations can mitigate challenges associated with power grid instability. A first industrial Internet of Things (IoT) electrical monitor (IIEM), within a plurality of IIEMs, is accessed. The first IIEM is coupled to a load management module. The first IIEM is also coupled to a first node within an electrical distribution system of an industrial environment. The industrial environment comprises a plurality of nodes. The industrial environment also includes a plurality of industrial devices. One or more of the industrial devices are coupled to the first node. The first IIEM monitors a frequency of alternating current (AC) power of the first node and detects that the frequency is below a first frequency threshold. The load management module throttles at least one function within a first industrial device that is within the plurality of industrial devices.

Disclosed embodiments provide a processor-implemented method for analysis comprising: accessing a first industrial IoT electrical monitor (IIEM) within a plurality of IIEMs, wherein the first IIEM is coupled to a load management module and a first node within a plurality of nodes within an electrical distribution system of an industrial environment, wherein the industrial environment includes a plurality of industrial devices, and wherein one or more industrial devices within the plurality of industrial devices are coupled to the first node; monitoring, by the first IIEM, a frequency of alternating current (AC) power of the first node; detecting, by the first IIEM, that the frequency that was monitored is below a first frequency threshold; and throttling, by the load management module, at least one function within a first industrial device within the plurality of industrial devices. In embodiments, the industrial environment comprises a data center. In embodiments, the first industrial device that was throttled comprises a compute device within the data center. In embodiments, the at least one function comprises a software-controlled compute load. In embodiments, the throttling includes reducing a rate of artificial intelligence (AI) tokenization.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for frequency deviation detection and response with IoT-enabled monitors.

FIG. 2 is a flow diagram for throttling a function.

FIG. 3 is an infographic for industrial environments.

FIG. 4 is a diagram of monitoring a data center.

FIG. 5 is a diagram of transferring a function to another data center.

FIG. 6 is a diagram of three-phase power.

FIG. 7 is a system diagram for frequency deviation detection and response with IoT-enabled monitors.

### DETAILED DESCRIPTION

The continued reliability of modern infrastructure depends heavily on the availability and stability of electrical power. As industries and digital systems become increasingly interconnected and power-intensive, disruptions in the electrical power supply, whether momentary or sustained, can lead to significant operational consequences. Effective monitoring of the power grid is therefore essential to ensure that potential issues are identified quickly and addressed in a timely manner. Early detection of anomalies, such as frequency deviation or voltage irregularities, enables systems to initiate corrective action before critical thresholds are breached. By continuously assessing the health of the electrical supply, organizations can implement proactive mitigation strategies tailored to the nature and severity of the disturbance. These strategies may include controlled shutdowns, temporary power state adjustments, redirection of workloads to unaffected systems, and other techniques. Such measures help preserve service continuity, safeguard sensitive equipment, and minimize disruption to core operations.

As electrical infrastructure evolves to accommodate dynamic demand and distributed energy sources, the ability to monitor and respond intelligently to power grid conditions becomes increasingly vital. For example, when the power grid experiences a failure or operates outside of acceptable parameters, the consequences can be both immediate and far-reaching. Service outages caused by loss of electrical supply can disrupt communications, halt production lines, and impair access to critical digital infrastructure. In addition to service interruption, degraded power quality, such as deviations in line frequency, voltage irregularities, or phase imbalances, can damage sensitive electronic equipment or lead to premature component wear. Systems designed for operation within tightly controlled electrical specifications may malfunction or shut down unexpectedly when exposed to out-of-specification conditions. These challenges highlight the broader risks associated with grid instability and underscore the importance of maintaining consistent, high-quality power delivery to support modern operations.

In disclosed implementations, any number of industrial Internet of Things (IoT) equipped monitors (IIEMs) can monitor the frequency of an alternating current (AC) power supply to detect deviations indicative of electrical grid instability. A first IIEM within a plurality of IIEMs is accessed. The first IIEM is coupled to a load management module and a first node within an electrical distribution system of an industrial environment. The industrial environment can comprise a data center. The industrial environment includes a plurality of industrial devices that is coupled to the first node. The industrial devices can include compute devices within a data center which include a function such as a software-controlled compute load. The first IIEM monitors a frequency of alternating current (AC) power of the first node and detects that the frequency that was monitored is below a first frequency threshold. A decline in frequency below a predetermined threshold can signal instability, potentially preceding brownouts or equipment malfunction. By monitoring this parameter in real time, the disclosed implementations can initiate mitigative actions to preserve operational integrity and reduce strain on the power infrastructure. In some embodiments, the frequency of AC power comprises 60 Hz and the first frequency threshold comprises 59.9Hz. In other embodiments, the frequency of AC power comprises 50 Hz and the first frequency threshold comprises 49.9Hz. The detecting can be based on a second frequency threshold. The load management module throttles at least one function within a first industrial device within the plurality of industrial devices. The throttling can include reducing a rate of artificial intelligence (AI) tokenization, reducing a crypto hash rate, adjusting a dynamic voltage and frequency scaling (DVFS) configuration, transferring a function to another industrial environment, shutting down at least one industrial device, or implementing other throttling techniques. Through such adaptive responses, disclosed implementations can reduce the likelihood of cascading failures and can contribute to improved stability and resilience of the power grid.

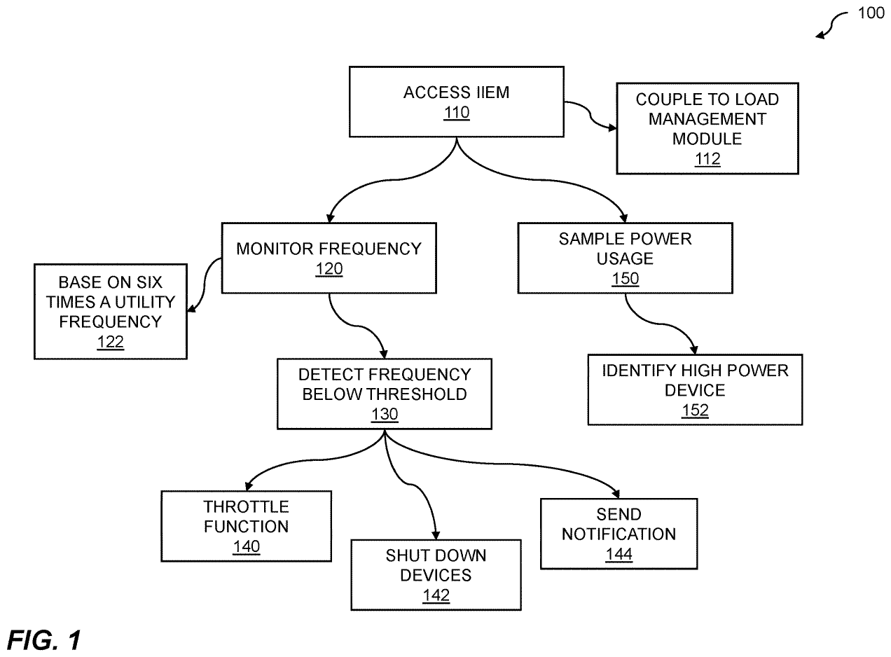

FIG. 1 is a flow diagram for frequency deviation detection and response with IoT-enabled monitors. The flow 100 begins with accessing an IoT electrical monitor (IIEM) 110. Embodiments include accessing a first industrial IoT electrical monitor (IIEM) within a plurality of IIEMs, wherein the first IIEM is coupled to a load management module and a first node within a plurality of nodes within an electrical distribution system of an industrial environment, wherein the industrial environment includes a plurality of industrial devices, and wherein one or more industrial devices within the plurality of industrial devices are coupled to the first node. The IIEM can be implemented using a single-board computer such as a Raspberry Pi®, NVIDIA Jetson®, BeagleBone® Black, Arduino® with suitable processing capabilities, or other comparable computing platforms capable of supporting the monitoring and communication functionalities described herein. In some implementations, a custom-designed computing device or embedded system may be used as an IIEM to achieve specific performance, form factor, or ruggedization requirements. The IIEM may directly monitor electrical characteristics of an input signal, such as voltage, current, phase, frequency, or power factor, and/or may receive electrical input data from other IoT-enabled sensors deployed within the monitored environment. Such data can include, for example, voltage levels, harmonic content, frequency stability, or other power quality parameters.

The IIEMs can be accessed via a wired or wireless network connection using protocols such as Ethernet, Wi-Fi (e.g., IEEE 802.11), Bluetooth Low Energy (BLE), Zigbee, LoRaWAN, or other suitable communications protocols, thereby enabling integration with broader industrial monitoring systems or cloud-based analytics platforms. Cybersecurity considerations can be incorporated to mitigate the risk of malicious actors attempting to spoof power frequency droop conditions. For example, in scenarios where the IIEM receives frequency data or other electrical measurements from external IoT-enabled sensors over a network, cryptographic techniques can be employed to authenticate the integrity and source of such data. In some implementations, data packets transmitted from sensors to the IIEM can include cryptographic hashes or digital signatures to verify that the data has not been altered in transit. In certain implementations, X.509 certificates or similar public key infrastructure (PKI) certificates can be used to establish a chain of trust between the IIEM and the external sensors, ensuring that only authorized sensors are permitted to provide operational data. Additionally, in some implementations, mutual authentication protocols can be utilized to verify the identities of both communicating devices prior to data exchange. Such measures can prevent denial-of-service attacks that attempt to trigger unnecessary equipment shutdowns or throttling based on falsified frequency droop data, thereby enhancing the operational security and reliability of the overall monitoring and response system.

The first IIEM is coupled to a first node. A node can refer to a monitoring point within the industrial facility, such as an electrical connection point that receives input power from an external AC power grid, or an intermediate distribution point within the facility's internal electrical network. For example, in some implementations, the first node may correspond to a main service entrance where utility power is received and distributed to facility subsystems, or may correspond to an internal distribution panel, sub-panel, or busbar segment within an industrial environment. In embodiments, the industrial environment comprises a data center. A node, such as the first node, can include measurement and protection equipment, such as current transformers (CTs), voltage sensors, or circuit protection devices, configured to monitor and manage power delivery to downstream coupled loads. The industrial environment can comprise many nodes and many IIEMs. Any number of IIEMs can be coupled to any number of nodes. In embodiments, the first IIEM is coupled to a second node, wherein the second node is within a plurality of nodes, and wherein one or more additional industrial devices within the plurality of industrial devices are coupled to the second node.

The flow 100 includes coupling the IIEM to a load management module 112. In embodiments, the load management module comprises an aggregation point. The load management module can be configured to receive information from one or more IIEMs, including data relating to voltage levels, frequency stability, harmonic distortion, power factor, and/or other electrical characteristics. Based on this information, the load management module can take mitigative action in response to AC power input signal characteristics being reported from the one or more IIEMs. Such mitigative actions can include throttling power consumption of connected equipment, initiating controlled shutdown sequences, transferring loads to backup power systems, issuing alerts to facility management personnel, etc. to prevent equipment damage or to maintain grid stability during frequency droop or other abnormal power conditions. In some embodiments, the aggregation point comprises an edge compute device within the industrial environment. The load management module can include a computing device located on the premises of the data center or industrial facility, such as a dedicated load management server, an industrial control system, an edge computing appliance integrated within the facility's electrical control infrastructure, etc. In other embodiments, the aggregation point comprises a cloud server. The load management module can be implemented as a cloud-based device, utilizing virtual machines, containerized applications orchestrated by platforms such as Kubernetes, and/or bare metal servers provisioned within a cloud service provider environment. The load management module can comprise hardware, software, or a combination of both.

The flow 100 includes monitoring a frequency 120. Embodiments include monitoring, by the IIEM, a frequency of alternating current (AC) power of the first node. The monitoring can include utilizing various AC power frequency monitoring technologies, such as employing current transformer (CT) magnetic sleeves that encircle a conductor to sense the alternating current waveform and derive its frequency, or using voltage sensing circuits coupled to the electrical node to measure zero-crossings for frequency calculation. In some implementations, Rogowski coils may be used as non-intrusive current sensors to measure the AC waveform characteristics without requiring direct electrical contact. Additionally, in certain implementations, the IIEM may include digital signal processing components or software algorithms configured to perform fast Fourier transform (FFT) analysis or zero-crossing detection on the sensed voltage or current signals to determine the fundamental frequency of the AC power at the node with high precision. In some embodiments, the monitoring is based on a sampling frequency. The sampling frequency can be 20kHz, or another suitable frequency.

The flow 100 can include basing on six times a utility frequency 122. In some embodiments, the monitoring is based on three-phase power. Three-phase power is a type of AC (alternating current) electrical power distribution that includes three sinusoidal voltage waveforms that are evenly spaced in phase, each offset by 120 degrees. Three-phase power is the most common technique used for transmitting and distributing electrical power in industrial, commercial, and high-power applications, because it provides a more balanced and efficient power delivery compared to single-phase systems. Disclosed monitoring approaches can leverage the characteristics of three-phase AC power systems, in which each of the three phases produces two zero-crossings per electrical cycle, one during the positive-going transition and one during the negative-going transition. As a result, for each complete cycle of the three-phase AC power signal, there are a total of six zero-crossings. Thus, in embodiments, the monitoring is based on at least six times an AC power frequency from a utility. By detecting and analyzing these six zero-crossings within each cycle, the IIEM can achieve higher temporal resolution and more precise frequency tracking. This multi-phase zero-crossing monitoring can enhance accuracy in determining slight variations or droop in the utility frequency, enabling faster and more reliable detection of abnormal conditions that could impact industrial equipment performance or grid stability.

The flow 100 can include detecting a frequency below a threshold 130. Embodiments can include detecting, by the first IIEM, that the frequency that was monitored is below a first frequency threshold. The threshold can comprise any suitable frequency and may vary by geographic location. For example, in the United States, the frequency of the power grid typically runs at 60 Hz. Thus, the first threshold can be set as a warning of possible grid instability, such as 59.9 Hz. In some embodiments, the frequency of alternating current (AC) power comprises 60 Hz. In some embodiments, the first frequency threshold comprises 59.9 Hz. In embodiments, the detecting is based on a second frequency threshold. Any number of thresholds can be used to indicate various levels of urgency. For example, a lower threshold can be used to indicate that grid instability is imminent. In some embodiments, the second frequency threshold comprises 59.5Hz. When the grid frequency becomes dangerously low, such as 59.5 Hz, more aggressive actions can be taken to restore grid stability. Embodiments include shutting down at least one industrial device within the plurality of industrial devices. Not all power grids run on the same frequency. For example, Europe's power grid typically runs at 50Hz. In that case, a first frequency threshold can be 49.9 Hz to warn of possible instability. In some embodiments, the frequency of alternating current (AC) power comprises 50 Hz. In some embodiments, the first frequency threshold comprises 49.9 Hz. Similar to above, the grid can implement one or more other thresholds to indicate various danger levels to grid stability. In some embodiments, the second frequency threshold comprises 49.5 Hz.

The flow 100 can include throttling a function 140. Embodiments include throttling, by the load management module, at least one function within a first industrial device within the plurality of industrial devices. As mentioned above, a crossing of the frequency of AC power below the first threshold can be an indication of grid instability. This can be due to demand of electrical power exceeding supply. In response, disclosed implementations can reduce or eliminate the load on the grid, thereby allowing the grid to restabilize. The throttling can include reducing the input to a compute device or industrial machine, to cause a reduction in power consumption. The throttling can include reducing a tokenization rate for artificial intelligence (AI) applications, reducing a crypto hash rate for cryptocurrency mining operations, adjusting processor and/or GPU operating parameters (e.g., via dynamic voltage and frequency scaling-DVFS), and/or taking other suitable actions. Recall that the industrial equipment can run on three-phase power. In embodiments, the monitoring, the detecting, and the throttling is based on any phase within the three-phase power.

The flow 100 can include shutting down devices 142. The devices can include computing devices in a data center. As described above, when grid instability is imminent, drastic actions can be taken to restore stability, such as shutting down at least one device. The shutdown can be on a device level, rack level, or other suitable level. By shutting down devices, damage to the devices due to AC power grid instability can be prevented. Moreover, by shutting down the devices, power grid stress can be reduced, thereby providing improved changes for AC power grid recovery without a complete AC power grid failure. While a utility can notify customers of grid instability, these approaches can take a relatively long time before load is reduced. This approach can be especially effective to remove load quickly, especially when one or more industrial environments, such as data centers, remove load on the grid due to IIEM-sensed frequency reductions.

The flow 100 can include sending a notification 144. In embodiments, the detecting includes sending, by the first IIEM, a notification to the load management module, wherein the sending is based on the detecting. In disclosed implementations, the IIEM can send a notification, which can be a periodic notification, regarding frequency. The period of the notification can be dynamic. As an example, in a steady state condition, where the AC power frequency is at a normal frequency (e.g., 60 Hz), the notification period can be at a first rate. For example, after the frequency of AC power has been established for a certain time period, such as 5 minutes, the sending can be updated to send a notification every 250 milliseconds. Any suitable rate can be used. However, upon detecting a deviation that falls below the first frequency threshold (e.g., 59.9 Hz), the notification period can be changed to a second rate. The second rate can be greater than the first rate to give additional insight and to quickly sense if the frequency dips lower. As an example, the second rate can be every 50 milliseconds. In some implementations, additional frequency thresholds can be used to define multiple notification rates, enabling a tiered response strategy depending on the severity of the frequency deviation. Furthermore, in certain implementations, the notification message can include not only frequency data, but also timestamp information, node identification, and integrity verification data, such as cryptographic hashes or digital signatures, to ensure secure and authenticated communication with the load management module. In this way, network traffic is minimized when AC power conditions are proper, conserving bandwidth and reducing network congestion, while ensuring that more frequent and detailed data is transmitted during abnormal or critical conditions to support rapid load management decisions.

The flow 100 can include sampling power usage 150. Embodiments can include sampling, by the load management module, a power usage by each industrial device within the plurality of industrial devices. The sampling can include retrieving data from sensors on the input to a particular industrial device, computing device, and/or rack within a data center. The flow 100 can further include identifying a high power device 152. In embodiments, the throttling includes identifying, by the load management module, one or more high power industrial devices, within the plurality of industrial devices, wherein the one or more high power industrial devices consume power above a power threshold. In disclosed implementations, each device that is monitored by IIEM(s) within the facility can be sorted based on current and/or average power consumption. The current and/or average power consumption can be used as a criterion for deciding which device to throttle so that load is reduced maximally when conditions warrant. For example, devices with the highest instantaneous or sustained power draw may be prioritized for throttling or shutdown actions to achieve the greatest reduction in overall facility load during a frequency droop condition, such as a frequency which crosses a first threshold, second threshold, or another threshold. In embodiments, the first industrial device that was throttled is included within the one or more high power industrial devices that were identified. In disclosed implementations, there can be more benefit to shutting down or throttling a device that is consuming a large amount of power, thereby enabling effective load shedding to stabilize power conditions. However, there can be other considerations in determining throttling priority, such as an assigned operational priority of the device; whether the device performs a critical process function; whether it is part of a safety-critical system such as emergency lighting, fire suppression controls, or life-supporting medical systems; and the potential operational or financial impact of reducing its performance. In some implementations, a multi-factor prioritization algorithm may be used, incorporating real-time power consumption data, device priority assignments, safety classifications, and production scheduling information to determine an optimized throttling sequence that maintains facility safety and operational continuity while responding effectively to detected power anomalies.

Various steps in the flow 100 may be changed in order, repeated, omitted, or the like without departing from the disclosed concepts. Various embodiments of the flow 100, or portions thereof, can be included in a computer program product embodied in a non-transitory computer readable medium that includes code executable by one or more processors.

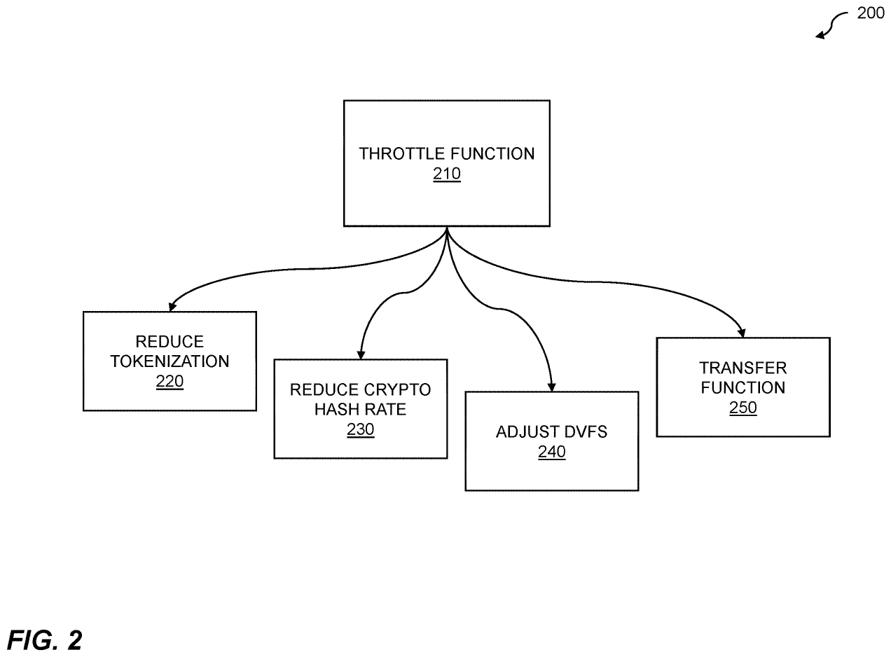

FIG. 2 is a flow diagram for throttling a function. The flow 200 starts with throttling a function 210. Embodiments include throttling, by the load management module, at least one function within a first industrial device within the plurality of industrial devices. As described previously, any number of functions within any number of devices across any number of industrial environments can be considered. In embodiments, the industrial environment comprises a data center. In embodiments, the first industrial device that was throttled comprises a compute device within the data center. The first industrial device can comprise a computer, a server, a switch, a rack, an HVAC unit, and so on. The function within the first device can be controlled by software. In embodiments, the at least one function comprises a software-controlled compute load. Software can start, stop, halt, pause, reduce, etc. the function within the first, as well as other, compute devices. The software-controlled compute load can enable a change in power consumption of an industrial device via changing parameters, sending messages, invoking APIs, and so on. Thus, the power consumed by the devices can be software controlled. The throttling can be accomplished via software and can be based on information sent from the load management module to the industrial devices.

The throttling can include a variety of methods. The flow 200 includes reducing tokenization 220. In embodiments, the throttling includes reducing a rate of artificial intelligence (AI) tokenization. Reducing the input to and/or output from a machine learning application, such as a large language model (LLM), can reduce overall power consumption while maintaining some level of service availability for AI-based applications. For example, in certain implementations, limiting the number of input tokens processed by the LLM can reduce the computational workload required for inference, thereby decreasing processor utilization and associated energy consumption. Similarly, constraining the maximum number of output tokens generated can shorten response times and reduce GPU or accelerator core usage, contributing to lower instantaneous power draw. In some implementations, adaptive tokenization strategies may be employed, wherein the system dynamically adjusts input or output token limits based on real-time power availability or detected frequency droop conditions. This enables the AI service to continue providing partial functionality or basic responses under constrained power conditions, rather than fully shutting down, thereby preserving critical operational capabilities such as alert generation, status reporting, or simplified natural language interfaces for operators.

The flow 200 can include reducing a crypto hash rate 230. In embodiments, the throttling includes reducing a crypto hash rate. The reducing can include slowing down the rate of cryptographic hashing operations performed during cryptocurrency mining processes, thereby reducing the power consumption of mining hardware such as central processing units (CPUs), application-specific integrated circuits (ASICs), and/or graphics processing units (GPUs). Reducing a hash rate of other applications can also help to temporarily conserve power. For example, in certain implementations, throttling the hashing operations used in data deduplication or integrity verification processes within storage systems can reduce the computational workload, while still maintaining basic storage functionality. Similarly, in secure communications systems, where hashing is used for frequent integrity checks or message authentication, the rate of such operations can be adjusted under constrained power conditions while preserving essential security operations at a reduced frequency. In some implementations, throttling hash-based password cracking or cryptanalysis processes in cybersecurity research environments can reduce power draw without halting ongoing research tasks entirely. Thus, reducing the rate of cryptographic hashing operations can provide a practical approach to power management across a variety of computationally intensive applications beyond cryptocurrency mining.

The flow 200 can include adjusting dynamic voltage and frequency scaling (DVFS) 240. In embodiments, the throttling includes adjusting a dynamic voltage and frequency scaling (DVFS) configuration. In disclosed implementations, the load management module can send control commands to various industrial devices, including compute devices such as servers, storage systems, and/or networking equipment within a data center or industrial control environment, to cause the devices to enter a lower power operational mode. For example, in some implementations, the load management module can instruct compute devices to reduce their operating voltages, thereby lowering power consumption at the processor and memory subsystems. Additionally, the load management module can command a reduction in processor clock frequencies, memory access speeds, peripheral bus rates, etc., leveraging DVFS parameters to achieve power savings while maintaining partial processing capabilities. In certain implementations, these DVFS adjustments can be performed dynamically in response to detected AC power frequency droop conditions, enabling the facility to rapidly reduce aggregate power demand while preserving critical computational workloads at a reduced performance level. This approach provides a practical and granular method to implement power throttling in environments with large-scale compute deployments, supporting operational continuity while contributing to grid stability during abnormal power conditions. In embodiments, the adjusting includes one or more central processing units (CPUs) within the data center. The adjusting can be applied to any number of processors, switching units, systems-on-chip (SoCs), and so on. In embodiments, the adjusting includes one or more graphics processing units (GPUs) within the data center. Some data centers can be focused on AI acceleration. Racks within these centers can include many GPUs which can be effective for AI acceleration. The adjusting can include these GPUs to increase the overall effectiveness of power savings.

The flow 200 can include transferring a function 250. In embodiments, the throttling comprises transferring the at least one function to another industrial environment. The transferring can include moving a compute task or operational workload from one facility to another geographically separated facility connected to a different AC power grid. For example, if a data center located in Texas detects a droop in fundamental frequency on its local grid, the load management module can initiate a task transfer process to maintain service continuity while reducing power consumption at the affected site. In such an implementation, the load management module can send a command to the Texas data center instructing compute devices to suspend their current computational tasks. The system can then serialize and package the current state of computation, including active memory contents, processor states, and relevant task context data, and can securely transmit this state data to a redundant data center located in New York that operates on an independent electrical grid. Upon receipt, the New York data center can deserialize the task state and resume computation with minimal disruption to operational workflows or end users. Following a successful transfer and verification of task continuity, the load management module can command the compute devices in the Texas data center to enter a low-power mode, hibernate, or shut down in order to reduce power draw and support grid stability. Such implementations leverage geographically distributed redundant systems to enable high-reliability, high-availability data center operations while dynamically responding to regional power grid conditions. Other means of moving workloads are possible. For example, the workloads on the data center in Texas can be shut down and restarted within the New York data center. To facilitate the movement, the load management module coupled to the Texas data center can communicate to the load management module coupled to the New York data center. The Texas load management module can make a request which can be accepted or denied by the New York load management module. If denied, the Texas load management module can request other data centers to transfer its functionality until the Texas grid is stabilized. Any of the throttling methods mentioned above can be applied to any number of functions within any number of industrial devices. In some embodiments, the throttling includes a second industrial device within the plurality of industrial devices. In some embodiments, the throttling includes at least one additional function within the first industrial device.

Various steps in the flow 200 may be changed in order, repeated, omitted, or the like without departing from the disclosed concepts. Various embodiments of the flow 200, or portions thereof, can be included in a computer program product embodied in a non-transitory computer readable medium that includes code executable by one or more processors.

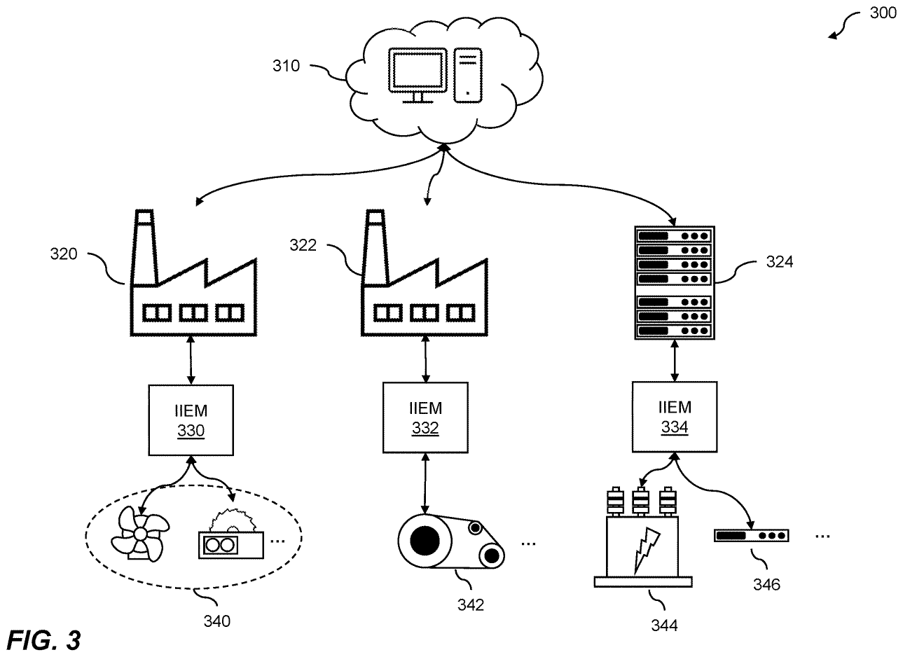

FIG. 3 is an infographic for industrial environments. An IoT environment can enable techniques for equipment monitoring. An industrial IoT electrical monitor (IIEM) can be accessed. The IIEM can be coupled to one or more industrial devices within one or more environments. The IIEM can detect and record any operating condition of electrical equipment such as voltage, current, humidity, temperature, vibration, and so on. The IIEM can receive one or more uploading instructions from a cloud server. The one or more uploading instructions can detail how and when the IIEM should upload electrical data to a cloud server. The IIEM can use different instructions for each coupled piece of electrical equipment. Electrical data associated with one or more industrial devices is recorded by the IIEM. The IIEM can determine whether the electrical data that was recorded represents an anomalous event which is related to the one or more industrial devices. The determining can be based on the one or more uploading instructions. The IIEM can send the electrical data to a cloud server, a load management module, other IIEMS, and so on. The IIEM can analyze, summarize, etc. the electrical data prior to the sending. This can include determining whether a frequency of AC power on a node within a power distribution system has fallen below one or more threshold levels.

The Internet of Things (IoT) can refer to a network of interconnected devices that can exchange information over a network such as the Internet, a mobile network such as 5G or long-term evolution (LTE), a private network, short-range communications networks such as Bluetooth, and so on. The devices can include any function for which communication is desired. For example, IoT devices can be used in securing a home with devices such as security cameras, smart thermostats, smart door locks, kitchen appliances, smoke detectors, and so on. These devices can communicate with other devices, systems, networks, etc. to report a status, an error, an alert, and so on. Software such as a web application or mobile application can accumulate data from IoT devices and show status, connectivity, battery power, live information, warnings, etc. associated with the devices. Many other applications of IoT devices are possible, such as fitness trackers, smart cars, smart lighting, smart appliances such as ovens and refrigerators, smart plugs and outlets, and so on. The industrial IoT (IIoT) is an extension of IoT for industrial devices to monitor function, environment, behavior, etc. of machines within industrial environments such as data centers, manufacturing facilities, power plants, wastewater treatment facilities, and many others. The devices can comprise sensors, instruments, machines, etc. that can exchange real-time data about the conditions of one or more machines within the environment, report problems, take actions (such as shutting off a machine), and so on. Such devices can include temperature sensors, pressure sensors, vibration sensors, flow sensors, actuators, monitors, programmable logic controllers (PLCs), and many more.

In disclosed implementations, the IIEM can include one or more processors, accelerators, switches, sensors, AI accelerators, and so on to enable processing, such as running a machine learning model, directly on the IIEM device, without the need for constant communication with a cloud server. This approach can reduce latency, enable faster response times for anomaly detection, and decrease the dependency on network connectivity. Moreover, by processing the data locally, sensitive information remains within the local network, addressing potential security and privacy concerns. This approach allows disclosed implementations to continuously monitor equipment, detect irregularities, and generate alerts or insights, making it an ideal solution for industries where uptime and predictive maintenance are critical. In disclosed implementations, the IIEM can comprise an IoT node which can interconnect devices, sensors, and servers to collect and exchange information over the Internet. The IIEM can include one or more communication transceivers. The communication transceivers can be based on BLE (Bluetooth Low Energy); Wi-Fi; cellular communication protocols such as 4G, 5G, and LTE-M; and/or other suitable communication protocols. The transceivers can enable high-speed data transfer to cloud servers and/or local networks. Other communication transceivers can include LoRa (Long Range) and/or Zigbee communication receivers. In some cases, one or more IoT nodes may include an ethernet port, serial port, and/or other port that supports wired communication, instead of, or in addition to, the communication transceivers.

In some implementations, the IIEM can be distinct from an IoT node, which can be an aggregation point. In those cases, one or more IIEMs within an environment can be coupled to one or more industrial devices. The one or more IIEMs can send data to the IoT device which can coordinate sending and receiving data with a compute device such as a computer, server, cloud server, load management module, etc. The IIEM can communicate with the IoT node via Bluetooth, cellular communications, and so on. In some cases, one or more IoT nodes may include an ethernet port, serial port, and/or other port that supports wired communication. The IIEM can include a power source. The power source can include a battery, such as a rechargeable battery. In disclosed implementations, the battery can include a lithium-ion battery, lithium-ion polymer battery, and/or other suitable type of battery. In some cases, one or more IIEMs may include PoE (power over ethernet) to enable providing both power and network connectivity via a single cable. Some IIEMs may include energy harvesting features, such as solar cells, vibration-based energy generation, and/or other renewable energy sources that can enable remote, self-sustaining IoT monitoring.

As mentioned above, the IIEMs can include one or more processors. The processors can include an ARM®-based processor, a MIPS®-based processor, a custom processor, application specific integrated circuits (ASICs), systems-on-chip (SoCs), one or more embedded controllers, and/or another suitable processor type. The processors can serve to read sensor data, process interrupts, perform communication tasks, and/or execute other processes to accomplish IoT-based industrial device monitoring. The processor(s) can interface with an input/output (I/O) module. The I/O module can include analog inputs to enable reading signals from analog sensors such as temperature probes, current meters, voltage meters, and so on. The I/O module can include one or more analog-to-digital converters (ADCs) to convert analog signal levels into digital values. The I/O module can include digital inputs and outputs, such as GPIO (General Purpose I/O), in order to interface with other types of sensors such as tilt sensors, gyroscopes, accelerometers, and/or other types of sensors that provide digital outputs. Additionally, the I/O module can interface with an output device, such as an LED, buzzer, or other suitable output device. The I/O module can interface to a wide variety of sensors. The sensors can include temperature and humidity sensors to monitor environmental conditions. The sensors can include vibration sensors, which can be used to detect mechanical wear and/or anomalies in industrial equipment. The sensors can include current sensors and voltage sensors, which can measure power consumption and/or detect electrical issues. Other types of sensors can be used in disclosed implementations.

The IIEM can include computer storage, such as flash memory, for storing firmware images, configuration settings, sensor logs, waveforms, and so on. Additionally, some IIEMs can include an external storage interface, such as a microSD card slot, to enable local retrieval of collected data and/or logs. The computer storage can also include random-access memory (RAM) for supporting program execution and in some cases, analysis and/or processing of collected data. The IIEM can be coupled to the one or more industrial devices via a network connection. The network connection can be a wireless connection, such as via BLE, Wi-Fi, or some other suitable connection. The network connection can be a wired connection, such as an ethernet connection, serial connection (e.g., RS-232, RS-485, or the like), and/or other type of wired connection. The coupling can include access, by the IIEM, to internal nodes of the industrial equipment to monitor internal conditions. The coupling can include access to current and/or voltage entering or exiting the industrial device. The one or more industrial devices can include robotic arms, CNC machines, 3D printers, welding machines, injection molding machines, conveyor belts, packaging equipment, sorting machines, uninterruptible power supplies, generators, power transformers, industrial circuit breakers, power distribution units, industrial HVAC systems, furnaces, boilers, refrigeration units, dehumidifiers and humidifiers, pumps, compressors, mixing tanks, water treatment systems, data center computer servers, processors, GPUs, network switches, routers, cooling equipment, and/or other types of industrial devices. Any type of equipment that requires electricity can be monitored by the IIEM. A single IIEM can be coupled to a single device or multiple devices, providing efficient IoT monitoring. Any environment can be monitored by the IIEM. For example, the equipment can be located in a room within a food processing facility, a rack within a data center, a floor within a manufacturing facility, and so on. Any number of IIEMs can be coupled to any number of industrial devices in any number of environments. In a usage example, a single IIEM can be coupled to a bandsaw and a table saw within a wood shop.

The infographic 300 includes a cloud server 310. In disclosed implementations, the cloud server 310 can be implemented as a bare metal server, one or more containerized instances, and/or one or more virtual machines. The cloud server can include a server in a cloud service such as Amazon Web Services® (AWS), a custom-managed server, a local server (e.g., on-site server, computer, and so on), etc. The cloud server can include any number of physical servers within a rack, data center, network, and so on. The cloud server can include any type of processor, ASIC, SoC, AI accelerator, etc. Load balancing and/or orchestration can be used to enable scaling of cloud server capabilities as the number of industrial devices being monitored increases. The cloud server can communicate with one or more IIEM devices located in various environments, such as facilities and/or locations which house equipment. The cloud server can communicate with the one or more IIEM devices via the Internet, cellular networks, satellite networks, and/or other suitable communication techniques. The IIEM can comprise an IoT node. The cloud server can communicate with one or more load management modules (not shown in infographic 300). The load management modules can be in the same environment, or in different environments. In some implementations, communication between industrial environments does not require a cloud server as load management modules can directly communicate to shared loads across different power grids.

As shown in infographic 300, a first IIEM 330 is installed within a first environment 320, a second IIEM 332 is installed within a second environment 322, and a third IIEM 334 is installed within a third environment 324. The first and second environments are shown as manufacturing facilities, and the third environment is shown as a data center. In practice, any environment can be monitored by the IIEM. For example, the equipment can be located in a room within a food processing facility, a rack within a data center, a floor within a manufacturing facility, outdoors, and so on. Any number of IIEMs can be coupled to any number of industrial devices in any number of environments. In a usage example, a single IIEM can be coupled to a bandsaw and a table saw within a wood shop. In the infographic 300, IIEM 330 monitors two industrial devices 340, a fan and a table saw, within environment 320. IIEM 332 monitors a single belt drive 342 within environment 322. IIEM 334 monitors a generator 344 and computing equipment 346 within environment 324, a data center.

Environment 320, environment 322, and environment 324 can be located in different geographical regions, or similar regions. They can be coupled to the same power grid or a different power grid. The industrial devices can include elevators, centrifuges, saws, drills, conveyor belts, CNC machines, 3D printers, welding machines, injection molding machines, robotic arms, packaging equipment, sorting machines, uninterruptible power supplies, generators, power transformers, industrial circuit breakers, power distribution units, industrial HVAC systems, furnaces, boilers, refrigeration units, dehumidifiers and humidifiers, pumps, compressors, mixing tanks, water treatment systems, data center computer servers, network switches, load balancers, uninterruptible power supplies, routers, and/or other types of industrial devices. The IIEMs shown in infographic 300 can capture data from the industrial equipment, and can analyze, summarize, and/or send the data to the cloud server. The IIEMs can be instrumental in recognizing and preventing industrial equipment failures.

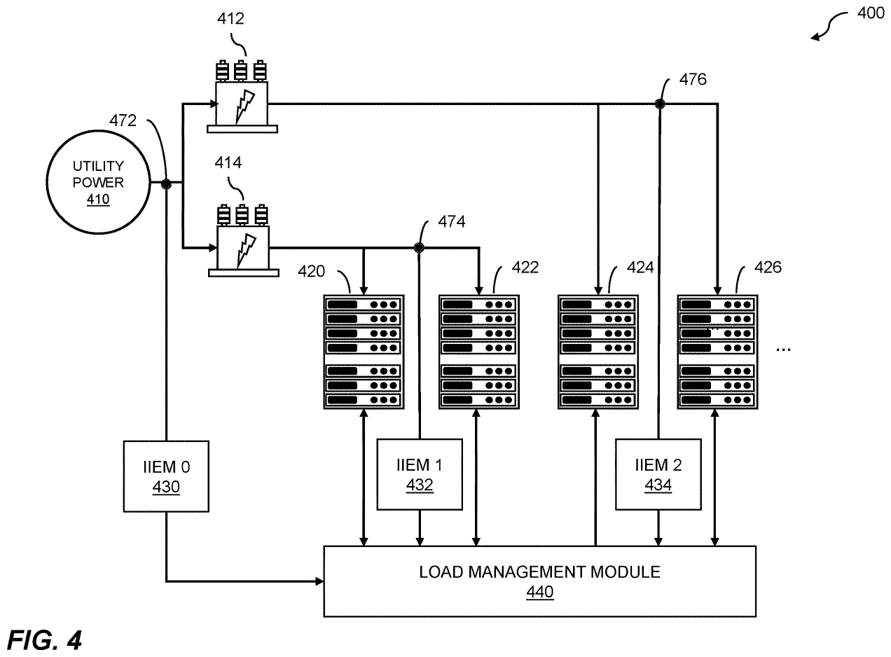

FIG. 4 is a diagram of monitoring a data center. The diagram 400 includes a utility power source 410, which can include a municipal power source, such as electrical power provided by a utility company to an industrial environment. In some implementations, the utility power source can additionally include locally generated power, such as power produced by onsite generators, uninterruptible power supplies (UPS) operating in generator mode, or backup diesel generators, thereby supporting enhanced power reliability during grid disruptions or outages.

The diagram 400 further depicts a first node 472, which includes input connections to a first transformer 412 and a second transformer 414, and is monitored by IIEM 0 430. Similarly, the diagram includes a second node 474 that includes input to a first data center rack 420 and an additional data center rack 422, and is monitored by IIEM 1 432. The diagram 400 also includes a third node 476, which includes input to data center rack 424 and an additional data center rack 426, and is monitored by IIEM 2 434. Each data center rack shown in the diagram 400 can include one or more compute devices, such as servers, load balancers, routers, network switches, disk storage arrays, or other data center infrastructure equipment configured to support computational and network workloads for enterprise or cloud services.

The load management module 440 is configured to receive information from the IIEMs distributed across the various nodes. The information received can include notifications indicating a detected droop in AC frequency at a monitored node, as well as periodic or event-driven power consumption reports for one or more devices within the facility or premises. The load management module can be implemented as a computing device located on premises within the data center, hosted in a cloud environment to enable remote access and centralized control, distributed as a hybrid solution combining on-premises hardware and remote cloud-based management platforms to ensure operational resiliency and scalability, and so on. Each IIEM can be coupled to one or more nodes. In embodiments, the IIEM is coupled to a second node, wherein the second node is within the plurality of nodes, and wherein one or more additional industrial devices within the plurality of industrial devices are coupled to the second node. IIEMs 430, 432, and/or 434 can detect a drop in frequency of AC power delivered to equipment within the data center. Any of the IIEMs can comprise a first IIEM as described above. In embodiments, the detecting includes sending, by the first IIEM, a notification to the load management module, wherein the sending is based on the detecting. The load management module can then take appropriate actions based on a threshold level reached. For example, in some embodiments, the frequency of alternating current (AC) power comprises 60 Hz. In some embodiments, the first frequency threshold comprises 59.9 Hz. Recall that an IIEM can be coupled to one or more industrial devices such as a first industrial device. When the first frequency threshold is reached, the load management module can throttle at least one function within a first industrial device within the plurality of industrial devices. The throttling can include reducing a rate of artificial intelligence (AI) tokenization, reducing a crypto hash rate, adjusting a dynamic voltage and frequency scaling (DVFS) configuration, transferring the at least one function to another industrial environment, or implementing another throttling method. The net effect can be a drop in load on the power grid (especially when multiple data centers carry out the same function on the same grid), thus restoring stability to the grid.

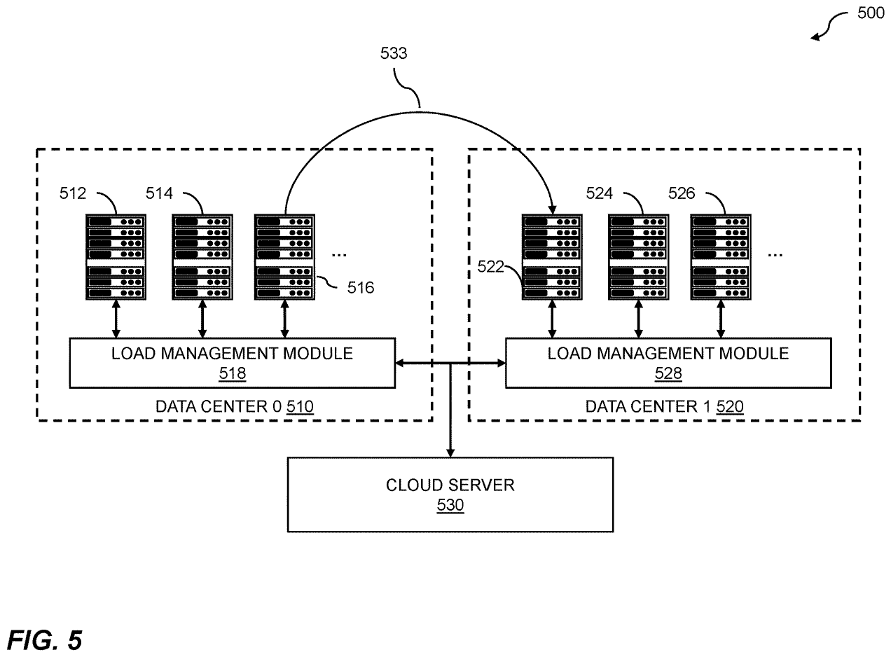

FIG. 5 is a diagram of transferring a function to another data center. The diagram 500 includes data center 0 510 and data center 1 520. Data center 0 510 and data center 1 520 can be supplied by different AC power grids, providing electrical independence between sites. In some cases, data center 0 510 and data center 1 520 can be geographically separated by significant distances to reduce correlated risks from regional power grid instability, natural disasters, or localized failures. The geographical separation can be any distance, for example, hundreds or even thousands of miles. As stated previously, data center 0 510 can be located in Texas while data center 1 520 can be located in New York, illustrating an example of substantial geographical separation to achieve functional redundancy and electrical grid operational resiliency.

Data center 0 510 includes a first data center rack 512, a second data center rack 514, and a third data center rack 516. Data center 0 510 also includes a load management module 518. Similarly, data center 1 520 includes a first data center rack 522, a second data center rack 524, and a third data center rack 526. Data center 1 520 also includes a load management module 528. While each data center depicted in diagram 500 shows three data center racks for illustrative purposes, in practice there can be more or fewer data center racks depending on the capacity, workload requirements, and architectural design of the respective facilities. Each data center rack can house compute devices such as servers, load balancers, network switches, disk arrays, and other critical infrastructure components necessary to support enterprise and cloud-based applications. Any data center can also include one or more load management modules.

Each load management module (518 and 528) can serve as an aggregation point. An aggregation point can serve as a centralized computing resource for collecting, analyzing, and interpreting electrical measurement data from transformers, IIEMs, and other industrial equipment within a facility. A major benefit to this approach is enabling rapid identification and localization of electrical anomalies, particularly frequency droop conditions, which can disrupt operations and pose safety or stability risks. By aggregating data from multiple Industrial IoT Electrical Monitors (IIEMs) spread throughout the facility, the aggregation point can correlate measurements such as fundamental frequency droop, current and voltage rise times, phase shifts, harmonic distortion, and peak amplitudes across equipment nodes. This holistic view allows disclosed implementations to quickly detect potential instabilities in the AC power being supplied to an industrial facility, enabling prompt mitigative actions to maintain operational continuity and equipment safety. In embodiments, the load management module comprises an aggregation point. In embodiments, the aggregation point comprises an edge compute device within the industrial environment.

Each load management module (518 and 528) communicates with cloud server 530. The cloud server may be hosted in another location, physically separate from data center 0 510 and data center 1 520, providing additional geographic redundancy. In embodiments, the aggregation point comprises a cloud server. The cloud server can be hosted via virtual machines, containerized applications orchestrated by platforms such as Kubernetes, bare metal servers, or other cloud infrastructure configurations. The cloud server can facilitate transferring of a compute load 533 from data center 0 510 to data center 1 520 in response to detecting AC power supply instability, such as fundamental frequency droop, at the site of data center 0 510, according to disclosed embodiments. For example, upon detection of a droop condition, such as a frequency of AC power below a threshold, the load management module 518 can initiate a transfer protocol to suspend active compute tasks, serialize and package the current state data, and send it to the cloud server 530, which coordinates delivery to data center 1 520. Once the needed information is received and compute operations are resumed at data center 1 520, one or more devices at data center 0 510 can be shut down, hibernated, or otherwise configured to reduce power consumption, thereby preserving operational continuity while supporting stability of the affected power grid. Alternatively, one or more functions running in data center 0 can simply be restarted within data center 1 via communication between the load management modules. In disclosed implementations, multiple devices can be throttled. In embodiments, the throttling includes a second industrial device within the plurality of industrial devices.

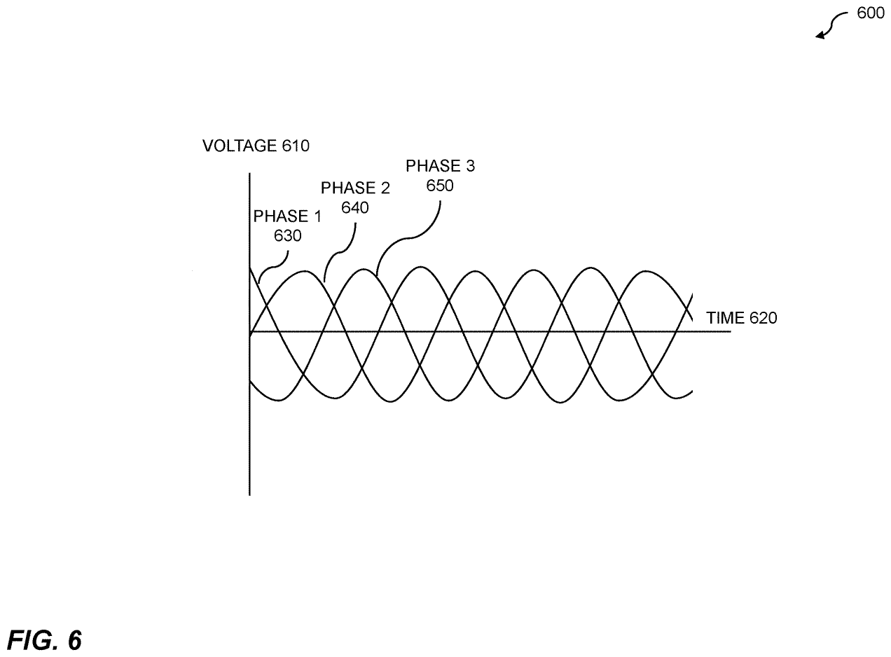

FIG. 6 is a diagram of three-phase power. The example 600 includes a horizontal axis 620 representing time, and a vertical axis 610 representing voltage magnitude. A first phase 630, second phase 640, and third phase 650 are shown. Three-phase power is a type of AC (alternating current) electrical power distribution that includes three sinusoidal voltage waveforms that are evenly spaced in phase, each offset by 120 degrees. Three-phase power is a common technique used for transmitting and distributing electrical power in industrial, commercial, and high-power applications, because it provides a more balanced and efficient power delivery compared to single-phase systems. In a balanced three-phase system, each voltage waveform has the same frequency and amplitude (e.g., peak voltage), which can minimize voltage fluctuations and reduce the need for oversized conductors or transformers. The phase relationships allow for constant power transfer, unlike single-phase systems that experience pulsating power delivery. The frequency can typically range from 50 Hz to 60 Hz, depending on geographic region. In disclosed implementations, the three-phase power can be in a wye (Y) configuration, which includes a neutral conductor, or a delta (Δ) configuration, which does not require a neutral and can be used in motor loads or balanced systems.

Three-phase power can offer significant advantages in both reliability and performance. One of its key benefits is the ability to provide power to large industrial motors more efficiently, as the rotating magnetic field generated by three-phase current provides smoother and more consistent torque compared to single-phase power. This can reduce mechanical vibration and prolong the life of connected equipment. Additionally, three-phase systems can carry more power over the same conductor size, improving infrastructure efficiency. Common applications include powering HVAC systems, pumps, compressors, conveyors, industrial robotics, and data center infrastructure. The symmetrical nature of three-phase power also allows for simpler electrical balancing and fault detection, making it an ideal foundation for disclosed monitoring systems that analyze and detect fundamental frequency deviations in real time. In embodiments, the industrial environment is based on three-phase power. Any phase within the three phases can experience a reduction in frequency. That is, phase 1 630 and phase 2 640 can be at 60 Hz, while phase 3 650 can run at a lower frequency such as 59.9 Hz. As such, disclosed implementations can perform analysis and throttling based on any phase. In embodiments, the monitoring, the detecting, and the throttling are based on any phase within the three-phase power.

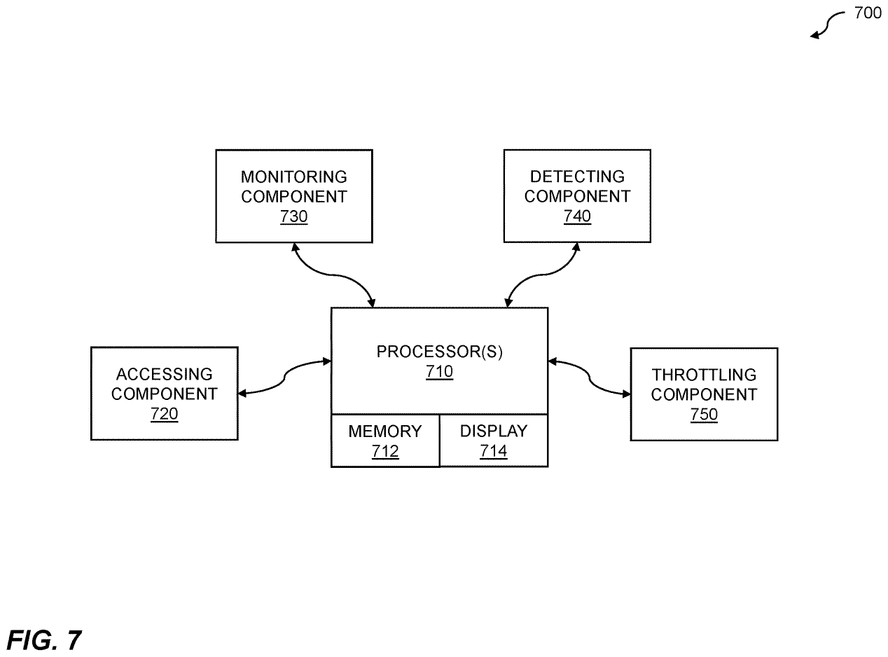

FIG. 7 is a system diagram for frequency deviation detection and response with IoT-enabled monitors. The system 700 can comprise a computer system for implementation of detection of and response to frequency deviations with IoT-enabled monitors. The computer system can be based on semiconductor logic. The system can include one or more of processors, memories, cache memories, queues, displays, communications channels and networks, and so on. The system 700 can include one or more processors 710. The processors can include standalone processors within integrated circuits or chips, processor cores in FPGAs or ASICs, two or more processor cores within a multiprocessor, and the like. The one or more processors 710 are coupled to a memory 712, which can store instructions, operations, network traffic data, data requests, electrical data analysis, heuristics for industrial environments, routing information, and so on. The memory can include one or more of local memory, shared cache memory, shared hierarchical cache memory, system memory such as shared system memory, etc. The system 700 can further include a display 714 coupled to the one or more processors. The display can be used for displaying data, instructions, operations, information regarding detection and response to frequency deviations with IoT-enabled monitors, and so on.

The system 700 can include a computer program product embodied in a non-transitory computer readable medium for analysis, the computer program product comprising code which causes one or more processors to perform operations of: accessing a first industrial IoT electrical monitor (IIEM) within a plurality of IIEMs, wherein the first IIEM is coupled to a load management module and a first node within a plurality of nodes within an electrical distribution system of an industrial environment, wherein the industrial environment includes a plurality of industrial devices, and wherein one or more industrial devices within the plurality of industrial devices are coupled to the first node; monitoring, by the first IIEM, a frequency of alternating current (AC) power of the first node; detecting, by the first IIEM, that the frequency that was monitored is below a first frequency threshold; and throttling, by the load management module, at least one function within a first industrial device within the plurality of industrial devices.

The system 700 can include a computer system for analysis comprising: a memory which stores instructions; and one or more processors coupled to the memory, wherein the one or more processors, when executing the instructions which are stored, are configured to: access a first industrial IoT electrical monitor (IIEM) within a plurality of IIEMs, wherein the first IIEM is coupled to a load management module and a first node within a plurality of nodes within an electrical distribution system of an industrial environment, wherein the industrial environment includes a plurality of industrial devices, and wherein one or more industrial devices within the plurality of industrial devices are coupled to the first node; monitor, by the first IIEM, a frequency of alternating current (AC) power of the first node; detect, by the first IIEM, that the frequency that was monitored is below a first frequency threshold; and throttle, by the load management module, at least one function within a first industrial device within the plurality of industrial devices.

The system 700 can include an accessing component 720. The accessing component 720 can include functions and instructions for accessing a first industrial IoT electrical monitor (IIEM) within a plurality of IIEMs, wherein the first IIEM is coupled to a load management module and a first node within a plurality of nodes within an electrical distribution system of an industrial environment, wherein the industrial environment includes a plurality of industrial devices, and wherein one or more industrial devices within the plurality of industrial devices are coupled to the first node. The accessing can include utilizing techniques such as establishing secure network connections over Ethernet or Wi-Fi to communicate with the IIEM. In some implementations, standard industrial communication protocols such as Modbus TCP, OPC UA, or MQTT can be used to facilitate reliable data exchange between the IIEM and supervisory systems or load management modules. Additionally, in certain implementations, RESTful APIs or gRPC-based interfaces can be employed to enable structured and efficient communication with remote computing devices, supporting configuration commands, status queries, and data retrieval operations. These techniques can provide secure, scalable, and low-latency connectivity to IIEM devices deployed across diverse industrial environments.

The system 700 can include a monitoring component 730. The monitoring component 730 can include functions and instructions for monitoring, by the first IIEM, a frequency of alternating current (AC) power of the first node. Frequencies of power grids can vary by location. In some embodiments, the frequency of alternating current (AC) power comprises 60 Hz. In disclosed implementations, the monitoring can include using one or more frequency thresholds as criteria for taking certain mitigation actions. For example, a first frequency threshold can be defined to detect minor deviations from nominal utility frequency. The first frequency threshold can be set to trigger a first level of mitigation that can include issuing warnings or alerts to facility operators and initiating moderate power reduction measures, such as throttling non-critical equipment or reducing computational workloads on select servers. In embodiments, the first frequency threshold comprises 59.9 Hz. Any number of thresholds can be used to indicate various levels of severity of frequency droop, causing the load management module to take additional actions to reduce load. For example, a second threshold can be used, where the second threshold corresponds to a more significant frequency deviation and can serve as a trigger for more drastic mitigation actions. In some embodiments, the detecting is based on a second frequency threshold. In some embodiments, the second frequency threshold comprises 59.5 Hz. Embodiments include shutting down at least one industrial device within the plurality of industrial devices. Other actions can include systematically shutting down non-essential equipment, transitioning critical workloads to backup power sources, or performing controlled shutdowns of high-power-consuming devices to protect equipment integrity and support grid stability. In this way, a multitiered approach can be used to handle reduced processing capacity gracefully, enabling the facility to maintain operational continuity as long as possible while implementing progressively stronger mitigation strategies based on the severity of detected frequency anomalies. In other locations, a power grid can run at 50 Hz, such as in Europe. In these cases, the thresholds can be adjusted accordingly. In embodiments, the frequency of alternating current (AC) power comprises 50 Hz. In some embodiments, the first frequency threshold comprises 49.9 Hz. In other embodiments, the detecting is based on a second frequency threshold. In embodiments the second frequency threshold comprises 49.5 Hz.

The system 700 can include a detecting component 740. The detecting component 740 can include functions and instructions for detecting, by the first IIEM, that the frequency that was monitored is below a first frequency threshold. In disclosed implementations, the detecting can include detecting zero-crossings of the AC waveform to calculate the instantaneous frequency based on the time interval between consecutive zero-crossings. Additionally, in some implementations, peak-to-peak duration measurements can be utilized, wherein the time between successive voltage or current peaks is measured to determine the fundamental frequency. Other suitable frequency detection techniques can also be employed, such as performing fast Fourier transform (FFT) analysis on the sampled waveform to identify the dominant frequency component or using phase-locked loop (PLL) circuits to continuously track frequency variations with high temporal resolution. These detection approaches enable precise monitoring of AC power frequency to support timely and appropriate mitigation actions.

The system 700 can include a throttling component 750. The throttling component 750 can include functions and instructions for throttling, by the load management module, at least one function within a first industrial device within the plurality of industrial devices. In disclosed implementations, the throttling can include reducing tokenization rates in AI processing applications to limit computational intensity, lowering crypto hash rates in cryptocurrency mining operations to reduce power draw, adjusting processor clock frequencies downward to conserve energy, reducing processor operating voltages via DVFS control to achieve further power savings, and so on. Other suitable throttling techniques can include disabling non-critical peripheral subsystems, placing idle compute cores into sleep states, or limiting network bandwidth utilization for lower-priority services to achieve an aggregate reduction in facility power consumption.

In disclosed implementations, the system can include functionality for determining that AC power grid stability has been restored. For example, upon detecting that the monitored frequency has returned to within nominal operational thresholds for a defined duration, the load management module can initiate procedures to remove throttling constraints where appropriate. In some cases, the load management module can send command messages to compute devices specifying updated DVFS parameters to restore processor clock frequencies and operating voltages to normal operational levels. For instance, a processor that was limited to operating at 1GHz during a frequency droop condition can be reconfigured to return to its standard 3GHz operating frequency once grid stability is confirmed.

In certain implementations, when devices were previously shut down entirely to conserve power, the load management module can communicate with smart power switches or programmable power distribution units to re-enable power delivery, bringing the devices back online automatically. To prevent sudden inrush current events or simultaneous high-load reactivation that could destabilize the facility or local grid, the restoration process can incorporate randomization or staggered backoff delays. For example, each device or device group can be assigned a random wait interval before reactivation, ensuring a gradual and controlled restoration of full operational capacity across the industrial environment. Such adaptive reactivation strategies enable the facility to return to normal operations efficiently while maintaining electrical stability and operational safety.

As can now be appreciated, disclosed implementations can provide the benefits of improved grid stability management while simultaneously enabling participation in important energy market programs. In particular, disclosed systems and methods can support participation in Power Demand Response Markets by facilitating the controlled reduction or shifting of electricity consumption during periods of high demand or system stress. Through the use of Industrial IoT Electrical Monitors (IIEMs) and load management modules, industrial facilities, data centers, and other large-scale energy consumers can reduce peak demand, preventing grid overload and contributing to overall grid reliability. In such implementations, customers can be incentivized to lower usage during grid strain events, with capacity payments rewarding participants for being available to reduce demand, and energy payments providing additional compensation for actual load reductions performed during demand response events. These capabilities provide predictable revenue opportunities tied to the frequency and magnitude of grid stress events, while enabling program incentives such as utility rebates and lower energy costs.

Additionally, disclosed implementations can support participation in Frequency Regulation Markets by enabling rapid and precise adjustment of power consumption to stabilize grid frequency within acceptable operational ranges. By leveraging fast-reacting throttling and load transfer capabilities, participants such as data centers or other industrial facilities can provide frequency regulation services in real time or near real time. Furthermore, participants employing disclosed implementations may command premium pricing by virtue of their rapid response capabilities and can dynamically adjust their market participation strategies between frequency regulation and other programs, such as energy arbitrage, based on real-time profitability assessments. Overall, disclosed implementations can provide a practical, scalable, and economically advantageous approach for industrial and data center operators to enhance operational resilience, support utility grid stability objectives, and access diverse revenue streams within modern electricity markets.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript®, ActionScript®, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for analysis comprising:
accessing a first industrial IoT electrical monitor (IIEM) within a plurality of IIEMs, wherein the first IIEM is coupled to a load management module and a first node within a plurality of nodes within an electrical distribution system of an industrial environment, wherein the industrial environment includes a plurality of industrial devices, and wherein one or more industrial devices within the plurality of industrial devices are coupled to the first node;
monitoring, by the first IIEM, a frequency of alternating current (AC) power of the first node;
detecting, by the first IIEM, that the frequency that was monitored is below a first frequency threshold; and
throttling, by the load management module, at least one function within a first industrial device within the plurality of industrial devices.

2. The method of claim 1 wherein the industrial environment comprises a data center.

3. The method of claim 2 wherein the first industrial device that was throttled comprises a compute device within the data center.

4. The method of claim 3 wherein the at least one function comprises a software-controlled compute load.

5. The method of claim 4 wherein the throttling includes reducing a rate of artificial intelligence (AI) tokenization.

6. The method of claim 4 wherein the throttling includes reducing a crypto hash rate.

7. The method of claim 4 wherein the throttling includes adjusting a dynamic voltage and frequency scaling (DVFS) configuration.

8. The method of claim 7 wherein the adjusting includes one or more central processing units (CPUs) within the data center.

9. The method of claim 7 wherein the adjusting includes one or more graphics processing units (GPUs) within the data center.

10. The method of claim 3 wherein the throttling includes a second industrial device within the plurality of industrial devices.

11. The method of claim 3 wherein the throttling includes at least one additional function within the first industrial device.

12. The method of claim 3 wherein the throttling comprises transferring the at least one function to another industrial environment.

13. The method of claim 1 wherein the industrial environment is based on three-phase power.

14. The method of claim 13 wherein the monitoring, the detecting, and the throttling is based on any phase within the three-phase power.

15. The method of claim 13 wherein the monitoring is based on at least six times an AC power frequency from a utility.

16. The method of claim 13 wherein the frequency of alternating current (AC) power comprises 60 Hz.

17. The method of claim 16 wherein the first frequency threshold comprises 59.9 Hz.

18. The method of claim 17 wherein the detecting is further based on a second frequency threshold.

19. The method of claim 1 further comprising sampling, by the load management module, a power usage by each industrial device within the plurality of industrial devices.

20. The method of claim 19 wherein the throttling includes identifying, by the load management module, one or more high power industrial devices, within the plurality of industrial devices, wherein the one or more high power industrial devices consume power above a power threshold.

21. The method of claim 20 wherein the first industrial device that was throttled is included within the one or more high power industrial devices that were identified.

22. The method of claim 1 wherein the detecting includes sending, by the first IIEM, a notification to the load management module, wherein the sending is based on the detecting.

23. The method of claim 1 wherein the first IIEM is coupled to a second node, wherein the second node is within the plurality of nodes, and wherein one or more additional industrial devices within the plurality of industrial devices are coupled to the second node.

24. A computer program product embodied in a non-transitory computer readable medium for analysis, the computer program product comprising code which causes one or more processors to perform operations of:
accessing a first industrial IoT electrical monitor (IIEM) within a plurality of IIEMs, wherein the first IIEM is coupled to a load management module and a first node within a plurality of nodes within an electrical distribution system of an industrial environment, wherein the industrial environment includes a plurality of industrial devices, and wherein one or more industrial devices within the plurality of industrial devices are coupled to the first node;
monitoring, by the first IIEM, a frequency of alternating current (AC) power of the first node;
detecting, by the first IIEM, that the frequency that was monitored is below a first frequency threshold; and
throttling, by the load management module, at least one function within a first industrial device within the plurality of industrial devices.

25. A computer system for analysis comprising:
a memory which stores instructions; and
one or more processors coupled to the memory, wherein the one or more processors, when executing the instructions which are stored, are configured to:
access a first industrial IoT electrical monitor (IIEM) within a plurality of IIEMs, wherein the first IIEM is coupled to a load management module and a first node within a plurality of nodes within an electrical distribution system of an industrial environment, wherein the industrial environment includes a plurality of industrial devices, and wherein one or more industrial devices within the plurality of industrial devices are coupled to the first node;
monitor, by the first IIEM, a frequency of alternating current (AC) power of the first node;
detect, by the first IIEM, that the frequency that was monitored is below a first frequency threshold; and
throttle, by the load management module, at least one function within a first industrial device within the plurality of industrial devices.
